(19) United States
(12) Patent Application Publication
(10) Pub. No.: US 2008/0184852 A1
(43) Pub. Date: Aug. 7, 2008

(54) Multi-Bit Drive With Drive Guide

(75) Inventor: Michael P. Peters, Lutherville, MD (US)

Correspondence Address: HARNESS, DICKEY & PIERCE, P.L.C., P.O. BOX 828, BLOOMFIELD HILLS, MI, 48303, US

(73) Assignee: BLACK & DECKER INC., Newark, DE (US)

(21) Appl. No.: 11/672,368

(22) Filed: Feb. 7, 2007

(51) Int. Cl. B25B 23/00

(52) U.S. Cl. 81/439

(57) ABSTRACT

A rotary tool includes a tool holder, a reversible bit, and an outer guide sleeve. The tool holder includes a socket and a shank. The socket includes an opening extending rearwardly from an end thereof. The shank is integral with and extends rearwardly from the socket and includes a non-circular cross-section. The reversible bit includes an inner sleeve, a first reversible bit driver, and a second reversible bit driver. The inner sleeve is disposed within the socket and rotates with the tool holder. One of the first and second bit drivers contains a bit having an end extending axially out of the socket opening. The outer guide sleeve is slidably coupled to and disposed over the socket. The outer guide sleeve is displaceable from a first position where a portion of the bit end extends outwardly beyond a first end of the outer sleeve to a second position where the bit end is completely disposed within the outer guide sleeve.

### FIELD

The present disclosure relates to a rotatable tool, and more specifically to a tool holder having a reversible bit assembly and a drive guide.

### BACKGROUND

The statements in this section merely provide background information related to the present disclosure and may not constitute prior art.

When purchasing various rotary tools, professional tradesmen and do-it-yourselfers are frequently required to purchase several of a series of tool or driver configurations that have different types of driving ends, e.g. Philips®, Torx® and flat head, as well as various hexagonal nut driver configurations in metric and English units. The combinations of different tools for a given task may require the use of various different driving ends. Thus, the cost associated with having a complete set of tools is increased since each tool is generally sold separately. Moreover, there is a significant drawback for a user of many different tools in that the user must carry with him or her a specific tool for each task to be accomplished. For example, a user may need to bring multiple screw drivers and nut drivers to accomplish a single task. As a consequence, the user's tool belt or tool box soon becomes cluttered with these various implements resulting in an increase in the weight of the tools the user must carry from one location to another. Likewise, boaters, motorists, bicyclists, and homeowners have a need for a single multipurpose rotary tool that can be stored conveniently and compactly for use in an emergency or otherwise.

Further, when using a rotary tool to drive a fastener it is often desirable to stabilize the fastener before it is engaged with a structure to ensure proper alignment. This often involves a user holding the fastener during initial engagement with the structure. This may result in discomfort or even injury to the user's hand. Depending on the rotary speed of the fastener at initial engagement, hand stabilizing may not even be a practical option.

All of these developments have created a need for a single rotary tool that has a variety of functions and serves as a multiple rotary tool, while eliminating the aforementioned inconveniences. However, this need has not been easily achieved. Hence, there exists a need for a single rotary tool and kit that functions as a multipurpose tool which can be stored and organized in a convenient manner and having the approximate size of a conventional single purpose rotary tool.

### SUMMARY

According to the present teachings, a rotary tool includes a tool holder, a reversible bit, and an outer guide sleeve. The tool holder includes a socket and a shank. The socket includes an opening extending rearwardly from an end thereof. The shank is integral with and extends rearwardly from the socket and includes a non-circular cross-section. The reversible bit includes an inner sleeve, a first reversible bit driver, and a second reversible bit driver. The inner sleeve is disposed within the socket and rotates with the tool holder. One of the first and second bit drivers contains a bit having an end extending axially out of the socket opening. The outer guide sleeve is slidably coupled to and disposed over the socket. The outer guide sleeve is displaceable from a first position where a portion of the bit end extends outwardly beyond a first end of the outer guide sleeve to a second position where the bit end is completely disposed within the outer guide sleeve.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is an exploded view of a rotary tool in association with a power tool having a keyless chuck or coupler interdisposed therebetween;

FIG. 2 is a cross-sectional view showing the inner coupling between the rotary tool and the coupler of FIG. 1;

FIG. 3A is a cross-sectional view of the rotary tool of FIG. 1 having a guide sleeve in a retracted position; and

FIG. 3B is a cross-sectional view of the rotary tool of FIG. 1 having a guide sleeve in an extended position.

### DETAILED DESCRIPTION

The following description is merely exemplary in nature and is not intended to limit the present disclosure, application, or uses.

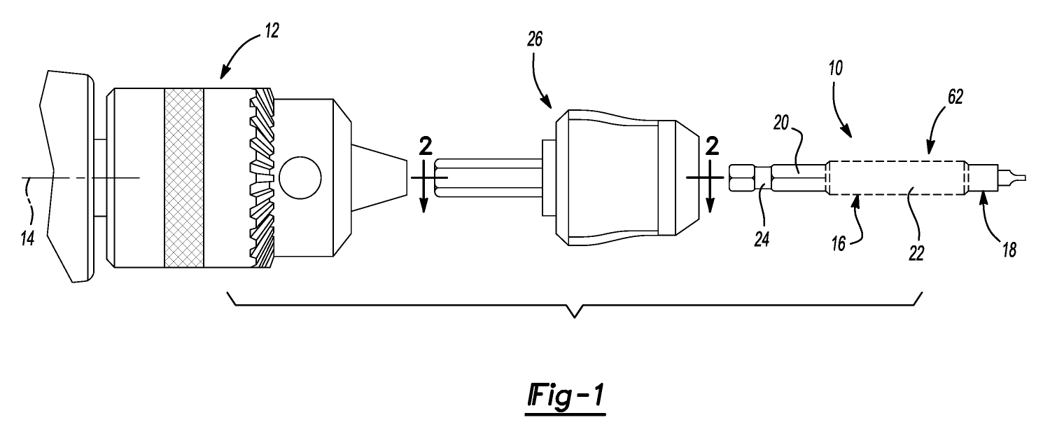

As shown in FIGS. 1-3B, a rotatable tool 10 is connectable to a power tool 12 or simply a handle (not shown) for rotation about an axis 14. As is described below, the rotatable tool 10 includes a tool holder 16 and a reversible bit assembly 18. The bit assembly 18 is releasably connectable to the tool holder 16, such as by spring biased detent balls, whereby the tool 10 provides six separate drivers for rotating a workpiece. The six drivers may include four bit drivers and two nut drivers. The flexibility of the tool 10 with regard to the number of drivers as well as the tool being configured to allow rotation by a power tool or handle provides advantages not previously provided in the art.

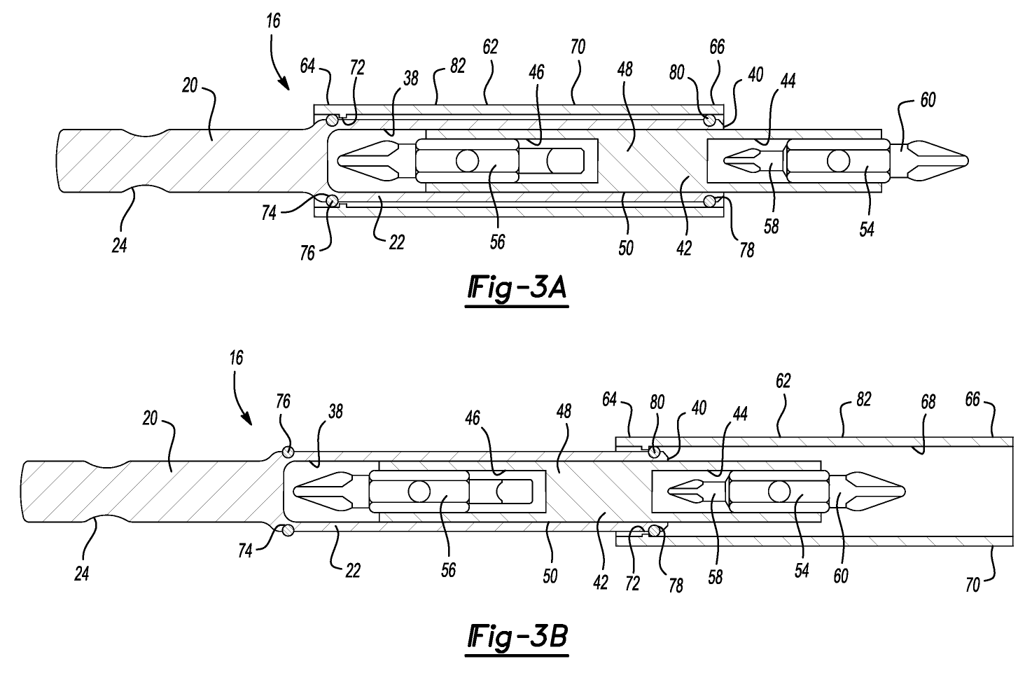

With reference to FIGS. 1, 3A and 3B, the tool holder 16 includes a shank 20 that is integral with, and that extends rearwardly from, a socket 22. The shank 20 may be hex-shaped and includes a circumferential groove 24. By this construction, the tool holder 16 is connectable to the drill or handle either directly or through a quick release coupler 26.

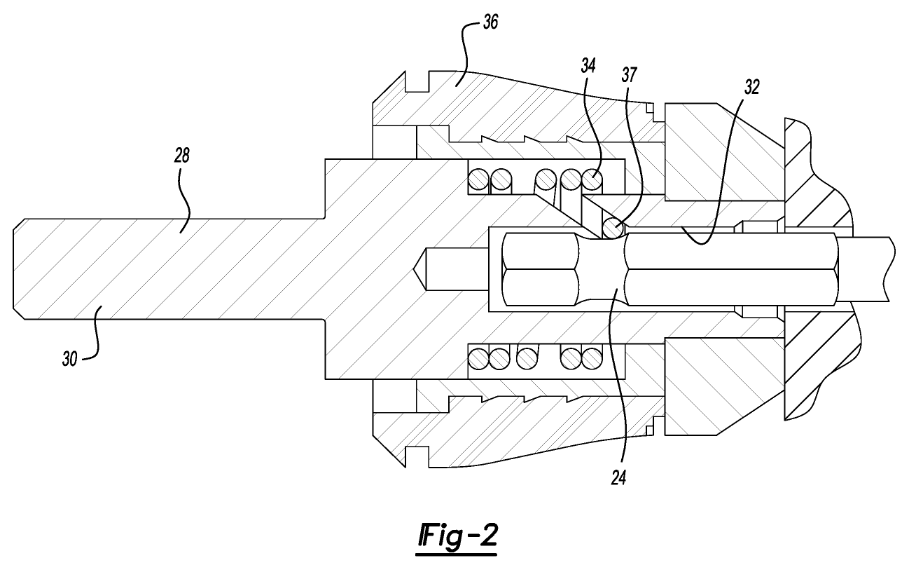

The coupler 26 is generally illustrated in FIG. 2 to include a body 28, having a shaft 30 and an axial opening 32, a detent spring 34, and an actuating sleeve 36. The tool holder shank 20 is disposable in the opening 32 wherein the spring 34 biases a pin 37 into engagement with the groove 24 to retain the shank 20 within the opening 32 for rotation with the coupler 26. A more detailed description of the coupler 26 is provided in U.S. Pat. No. 6,053,675, assigned to the assignee of the present application, and entitled “Quick-Acting Tool Bit Holder”, the disclosure of which is hereby incorporated by reference.

The tool socket 22 includes a bore 38 that extends axially inward from socket end 40 and may also be preferably hex-shaped. The reversible bit assembly 18 includes a sleeve 42 having a pair of axial storage cavities 44 and 46 separated by a web 48. The outer surface 50 of the sleeve 42, each of the cavities 44 and 46, as well as a center section 52 of first and second bit drivers 54 and 56 are each again preferably hex-shaped such that each of the bit drivers 54 and 56 rotate with the sleeve 42 and socket 22. The configuration of a representative tool holder and bit assembly, including the socket, sleeve, and bit drivers, are illustrated and described in greater detail in commonly assigned U.S. Pat. No. 6,354,177, issued Mar. 12, 2002 to Peters and entitled “6 in 1 Rotary Tool,” the disclosure of which is hereby incorporated by reference.

Each of the first and second bit drivers 54 and 56 are reversible within their respective cavities 44 and 46 such that either of the bit ends 58 or 60 can extend from sleeve 42. Additionally, the sleeve 42 is reversible within the socket bore 38 such that either the first or second bit drivers 54, 56 operably extend from the socket 22. Accordingly, the tool 10 may be configured such that any of the four bit driver ends operably project from the socket 22. Further, either of the bit drivers 54 and 56 may be removed from the sleeve 42 to expose the hex-shaped cavity 44 or 46 for use as a nut driver. Finally, the tool's sixth driver is provided by removing the reversible bit assembly 18 from the socket bore 38 to expose the hex-shaped bore 38 for use as a second nut driver. It should be noted that bore 38 is larger than cavities 44 and 46, thereby drivably accommodating larger nuts. The bore 38 may be a 5/16 inch hex-opening while the cavities 44, 46 may each be ¼ inch hex-openings.

An outer guide sleeve 62 extends over socket 22 and is axially movable from a retracted position (FIG. 3A) to an extended position (FIG. 3B). Guide sleeve 62 includes first and second ends 64, 66. Guide sleeve 62 further includes a radially inner portion 68 and a radially outer portion 70. First end 64 may include a protrusion 72 extending radially inwardly from inner portion 68. Socket 22 may include a first recess 74 near shank 20 having a C-clip 76 located therein. A second recess 78 may be located in socket 22 near socket end 40 and may also include a C-clip 80 therein. Sleeve 62 may be positioned on socket 22 such that protrusion 72 is located between C-clips 76, 80.

Sleeve 62 may have an inner diameter slightly greater than the outer diameter of socket 22. C-clips 76, 80 may extend radially outwardly a first distance from socket 22. Protrusion 72 may extend radially inwardly a second distance from sleeve inner portion 68. The first and second distances may be sufficient to trap protrusion 72 within C-clips 76, 80. The range of travel of sleeve 62 to retracted and extended positions may therefore be controlled by the distance between C-clips 76, 80.

Guide sleeve 62 may be a substantially cylindrical body 82 having an inner diameter large enough to house a fastener therein. Guide sleeve 62 may have a length sufficient to house the length of a fastener therein as well. More specifically, when in a retracted position (FIG. 3A), second end 66 of guide sleeve 62 may be generally aligned with socket end 40, thereby allowing socket bore 38 to be used as a nut driver. When in an extended position (FIG. 3B), second end 66 of guide sleeve 62 may extend beyond bit end 60 and may substantially surround an exposed portion of a fastener (not shown) and generally abut a structure (not shown) that the fastener is being driven into.

Guide sleeve 62 may be rotatably mounted on socket 22. More specifically, there may be a clearance between inner portion 68 and socket 22. Alternatively, a rotation preventing feature (not shown) may be formed on guide sleeve 62 or socket 22. Guide sleeve 62 may be formed from a variety of materials including metals and plastics. Additionally, an elastomer coating may be formed on an outer portion thereof.

Guide sleeve 62 may further include a magnetic portion. The entire guide sleeve 62 may be manufactured from a magnetic material, such as a rare earth magnetic material. Alternatively, a portion of guide sleeve 62 may be magnetic. More specifically, ½″ to 1″ of second end 66 may be magnetic. The magnetic portion may be in the form of an independent member in a press fit engagement with guide sleeve 62. In yet a further example, a magnetic surface treatment may be applied to guide sleeve inner portion 68. The surface treatment may include a rare earth magnetic material. In another example, guide sleeve 62 may be formed as a molded part. During the molding process, magnetic particles may be disposed in guide sleeve 62. More specifically, rare earth magnetic particles may be disposed in guide sleeve 62 near second end 66. Alternatively, or additionally, bit ends 58, 60 may be magnetic bit ends, thereby providing additional retention between a fastener and rotary tool 10.

What is claimed is:

1. A rotary tool comprising:
a tool holder including a socket and a shank, said socket having a first end, a second end, and an opening extending rearwardly from said first end toward said second end, said shank being integral with and extending rearwardly from said second end of said socket, said shank having a non-circular cross-section;
a reversible bit having a sleeve, a first reversible bit driver, and a second reversible bit driver, said sleeve including first and second axial end cavities, said first bit driver disposed in said first axial end cavity and coupled to rotate with said sleeve, said second bit driver disposed in said second axial end cavity and coupled to rotate with said sleeve, said first and second axial end cavities being of sufficient axial length to accommodate said first and second reversible bit drivers, and wherein said sleeve is disposed within said socket opening such that said sleeve rotates with said tool holder and one of said first and second bit drivers contains a bit having an end extending axially out of said socket opening; and
an outer guide sleeve slidably coupled to and disposed over said socket, said outer guide sleeve displaceable from a first position wherein a portion of said bit end extends outwardly beyond a first end of said outer guide sleeve to a second position wherein said bit end is completely disposed within said outer guide sleeve.

2. The rotary tool of claim 1, wherein said socket defines a hexagonal 5/16-inch nut driver to rotate a workpiece.

3. The rotary tool of claim 1, wherein said first axial end cavity defines a hexagonal ¼-inch nut driver to rotate a workpiece.

4. The rotary tool of claim 1, wherein said second axial end cavity defines a hexagonal ¼-inch nut driver to rotate a workpiece.

5. The rotary tool of claim 1, wherein said outer guide sleeve is configured to extend beyond said bit end a distance generally equal to the length of a fastener engaged with said bit end when in an extended position.

6. The rotary tool of claim 1, wherein said outer guide sleeve is configured to house a fastener therein.

7. The rotary tool of claim 1, wherein said outer guide sleeve is rotatably coupled to said socket.

8. The rotary tool of claim 1, wherein said bit is a magnetic bit.

9. The rotary tool of claim 1, wherein said outer guide sleeve includes a magnetic portion.

10. A rotary tool comprising:
a tool holder including a shank and a socket, said shank being coupled for rotation with said socket and adapted to be coupled to a power driven rotary drive, said socket defining a first nut driver for rotating a workpiece;
a reversible bit including a sleeve disposed in an opening in said socket and defining first and second end cavities, a first bit driver having a first bit end and a second bit end, and a second bit driver having a first bit end and a second bit end, said first bit driver being selectively disposable within said first end cavity for rotation with said sleeve in a first position where said first bit end extends from said sleeve and said socket and a second position where said second bit end extends from said sleeve and said socket, said second bit driver being selectively disposable within said second end cavity for rotation with said sleeve in a first position where said first bit end of said second bit driver extends from said sleeve and said socket and a second position where said second bit end of said second bit driver extends from said sleeve and said socket, said first bit driver being removable from said first end cavity wherein said first end cavity defines a second nut driver for rotating a workpiece, said first end cavity being smaller than said socket; and
an outer guide sleeve slidably coupled to and disposed over said socket, said outer guide sleeve displaceable from a first position wherein a portion of one of said bit ends extends outwardly beyond a first end of said outer guide sleeve to a second position wherein one of said bit ends is completely disposed within said outer guide sleeve.

11. The rotary tool of claim 10, wherein said outer guide sleeve is configured to extend beyond said one of said bit ends a distance generally equal to the length of a fastener engaged with said one of said bit ends when in an extended position.

12. The rotary tool of claim 10, wherein said outer guide sleeve is configured to house a fastener therein.

13. The rotary tool of claim 10, wherein said outer guide sleeve is rotatably coupled to said socket.

14. The rotary tool of claim 10, wherein said one of said bit ends is a magnetic bit end.

15. The rotary tool of claim 10, wherein said outer guide sleeve includes a magnetic portion.

16. A tool assembly comprising:
a quick release coupler having a shank, a body, and a detent assembly, said shank adapted to be coupled to a handle or a power tool, said body defining a passage;
a tool holder having a shank and a socket, said shank being disposable in said passage and engaged by said detent assembly whereby said tool holder is coupled for rotation with said coupler;
a reversible bit having a sleeve disposed in an opening in said socket, a first bit driver, and a second bit driver, said sleeve including first and second axial end cavities, said first bit driver disposed in said first axial end cavity and coupled to rotate with said sleeve, said second bit driver disposed in said second axial end cavity and coupled to rotate with said sleeve, and wherein said sleeve is disposed within said socket opening such that said sleeve rotates with said tool holder and one of said first and second bit drivers extends axially out of said socket opening, said one of said first and second bit drivers extending from said opening including a bit end extending therefrom; and
an outer guide sleeve slidably coupled to and disposed over said socket, said outer guide sleeve displaceable from a first position wherein a portion of said bit end extends outwardly beyond a first end of said outer guide sleeve to a second position wherein said bit end is completely disposed within said outer guide sleeve.

17. The rotary tool of claim 16, wherein said outer guide sleeve is configured to extend beyond said bit end a distance generally equal to the length of a fastener engaged with said bit end when in an extended position.

18. The rotary tool of claim 16, wherein said outer guide sleeve is configured to house a fastener therein.

19. The rotary tool of claim 16, wherein said bit end is a magnetic bit end.

20. The rotary tool of claim 16, wherein said outer guide sleeve includes a magnetic portion.
